(19) United States
(12) Patent Application Publication
(10) Pub. No.: US 2014/0331827 A1
(43) Pub. Date: Nov. 13, 2014

(54) SCREWDRIVER WITH SCREWDRIVER MOUNTING HANDLE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: XIAN-DONG ZHAO, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/251,178

(22) Filed: Apr. 11, 2014

(30) Foreign Application Priority Data
May 10, 2013 (CN) 2013101695323

(51) Int. Cl. B25B 23/00; B25B 15/02; B25B 23/16; B25B 15/00

(52) U.S. Cl. CPC B25B 23/0042; B25B 15/001; B25B 15/02; B25B 23/16
USPC 81/438

(57) ABSTRACT

Screwdriver includes a screwdriver mounting handle and a tool. The handle defines a through hole and a positioning groove communicating with the through hole. The tool includes a long arm and a short arm extending substantially from an end of the long arm, wherein the long arm protrudes from the screwdriver mounting handle via the through hole, and the short arm is fixedly clamped in the positioning groove.

### FIELD

The present disclosure generally relates to screwdrivers, and particularly to a screwdriver with a screwdriver mounting handle.

### BACKGROUND

A screwdriver is a tool, manual or powered, for turning (driving or removing) screws. Two typical screwdrivers are L-shaped wrench screwdriver and T-handle screwdriver. A typical simple of the L-shaped wrench screwdriver includes a long arm and a short arm extending substantially perpendicularly from an end of the long arm. It is difficult to apply a high force via the short arm because different lengths of the long arm and the short arm in operations. A common T-handle screwdriver includes a handle and a tool integrated with the handle. However, the screwdriver mounting handle and the tool are easily damaged in use.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 illustrates an assembled, isometric view of a first embodiment of a screwdriver including a positioning member.

FIG. 2 illustrates an exploded view of the screwdriver of FIG. 1.

FIG. 3 illustrates a cross section of the positioning member of FIG. 2 along line III-III.

FIG. 4 illustrates a cross section of the screwdriver of FIG. 1 along line IV-IV.

FIG. 5 illustrates a cross section of a screwdriver of a second embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

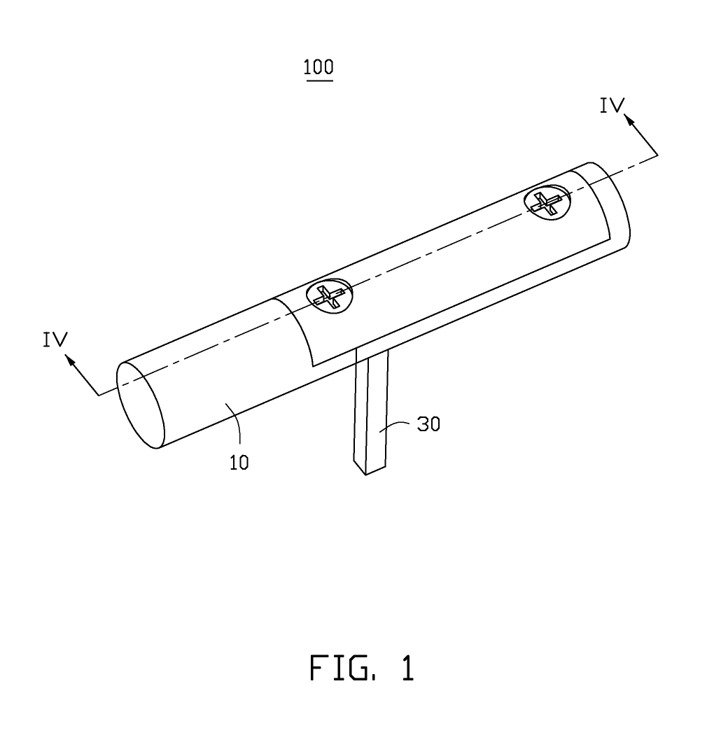

FIG. 1 illustrates a screwdriver 100 for turning (driving or removing) screws (not shown). The screwdriver 100 can be substantially T-shaped, including a screwdriver mounting handle 10 and a tool 30.

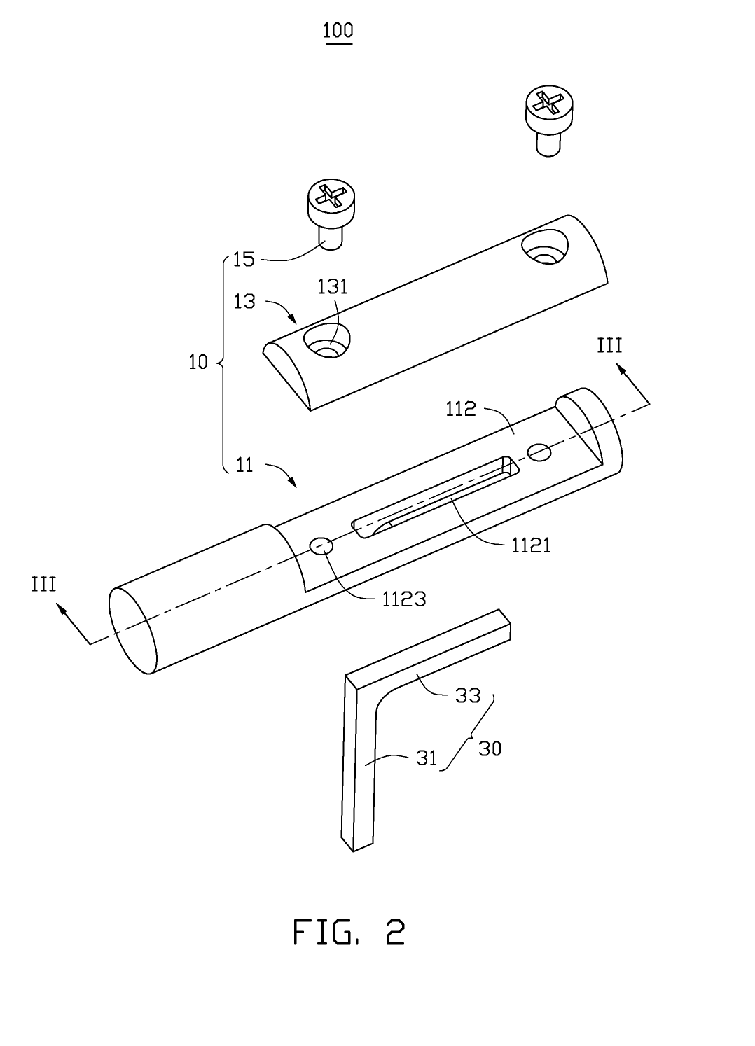

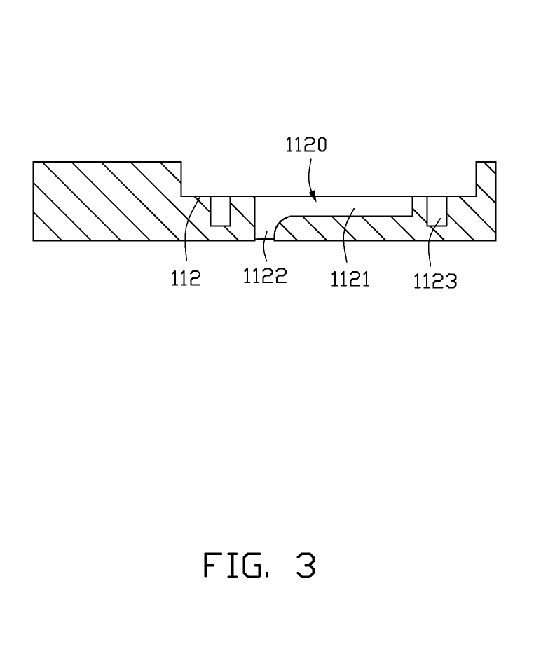

FIGS. 2 and 3 illustrate the screwdriver mounting handle 10. The screwdriver mounting handle 10 can be substantially cylindrical rod. The screwdriver 100 can include a positioning member 11, a fixing member 13, and two fasteners 15. A receiving portion 112 can be recessed in a side portion of the positioning member 11. A positioning groove 1121 can be formed in a bottom of the receiving portion 112 along a longitude direction of the receiving portion 112. A through hole 1122 is formed in a bottom of the positioning groove 1121. Sidewalls of the receiving portion 1121 and sidewalls of the positioning groove 1121 can cooperatively form a receiving space 1120 for receiving the tool 30. In illustrated embodiment, the receiving space 1120 is L-shaped. Two mounting grooves 1123 can be recessed in the bottom of the receiving portion 112. The positioning groove 1121 is located between the two mounting grooves 1123.

The fixing member 13 can engage with the receiving portion 112 of the positioning member 11. The fixing member 13 can be mounted on the receiving portion 112 and can be positioned above the two mounting grooves 1123 and the positioning groove 1121. Two fixing holes 131 can be defined in the fixing member 13 corresponding to the mounting groove 1123. The positioning member 11 and the fixing member 13 can be metal or other high strength material. Thereby, the positioning member 11 and the fixing member 13 are hard to be cracked during operations. The fixing member 13 can be fastened with the positioning member 11 via the two fasteners 15. Each fastener 15 can pass through and can be locked in one fixing hole 131. In illustrated embodiment, the fasteners 15 are screws.

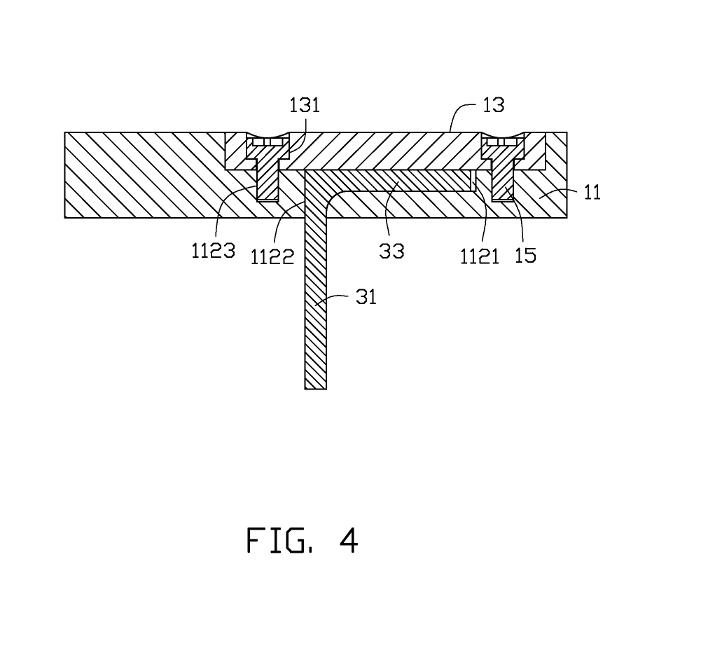

FIGS. 2 and 4 illustrate that the tool 30 can be substantially L-shaped and mounted in the positioning groove 1121. The tool 30 can include a long arm 31 and a short arm 33 extending substantially perpendicularly from an end of the long arm 31. In the illustrated embodiment, the tool 30 is an L-shaped wrench screwdriver, and a length of the long arm 31 is greater than that of the short arm 33. The long arm 31 can pass through the through hole 1122 and can protrude from the positioning member 11 away from the short arm 33. The short arm 33 can be received in the positioning groove 1121. A side surface of the fixing member 13 can resist against the short arm 33 for securely fixing the tool 30 with the positioning member 11. In other embodiments, a shape of the positioning groove 1121 can fit the short arm 33. The receiving space 1120 can be T-shaped, and the tool 30 can be T-shaped corresponding to the positioning groove 1121.

In a disassembly of the screwdriver 100 for replacing a new tool, the two fasteners 15 are detached from the fixing member 13, and the tool 30 is drawn out from the receiving space 1120. A new tool can be assembled within the screwdriver mounting handle 10.

As described above, the tool 30 can be detachably assembled with the screwdriver mounting handle 10. The screwdriver mounting handle 10 can be made of tough material. The positioning groove 1121 can be formed in the receiving portion 112. A short arm 33 can be received in the positioning groove 1121, and the long arm 31 can protrude from the receiving groove 1121. Force is applied more conveniently relative to a traditional screwdriver without a screwdriver mounting handle.

In other embodiments, the number of the fasteners 15 is not limited to two, and the number of fasteners can be one, three, or more. The numbers of the fixing holes 131 and the mounting grooves 1123 correspond to the number of the fasteners 15. When the fasteners 15 are omitted, the fixing member 13 can be mounted on the receiving portion 112 of the positioning member 11. The fixing member 13 can resist against the short arm 33 for clamping the tool 30 between the positioning member 11 and the fixing member 13. When the fixing member 13 and the fasteners 15 are omitted, and the short arm 33 can be securely clamped in the positioning groove 1121.

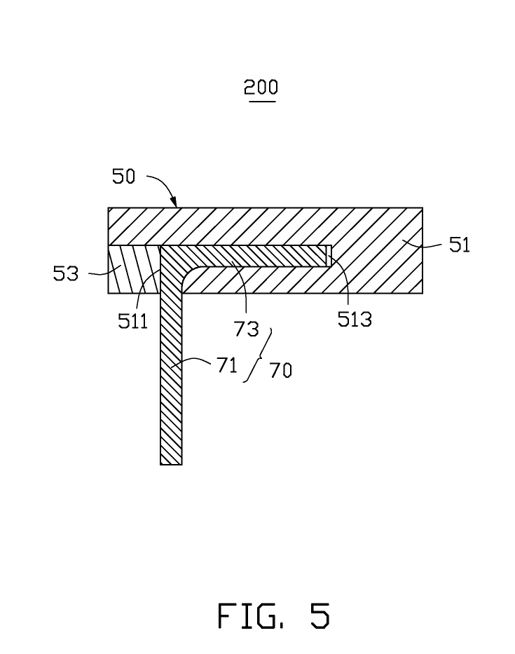

FIG. 5 illustrates a screwdriver 200 of a second embodiment. A difference exists between the screwdriver 200 of the first embodiment and the screwdriver 200 of the second embodiment is that screwdriver mounting handle 50 can include a positioning member 51 and a fixing member 53. A through hole 511 and a positioning groove 513 can be defined in the positioning member 51 along a longitudinal direction thereof and communicate each other. The through hole 511 is located adjacent to the screwdriver mounting handle 50. The through hole 511 and the positioning groove 513 can together define a receiving space (not shown) for receiving a tool 70. In the second embodiment, a cross section of the receiving space is L-shaped. In other embodiments, the screwdriver mounting handle 50 can be made of a metal or other high strength material.

The tool 70 can includes a long arm 71 and a short arm 73 extending substantially perpendicularly from the long arm 71. The long arm 71 can protrude from the screwdriver mounting handle 50 via the through hole 511 and can resist against the fixing member 53. The short arm 73 is fixedly clamped in the positioning groove 513. In other embodiments, the fixing member 53 can be omitted, and the short arm 73 can be fixedly clamped in the positioning groove 513.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A screwdriver comprising:
a screwdriver mounting handle defining a through hole and a positioning groove communicating with the through hole; and
a tool comprising a long arm and a short arm extending substantially from an end of the long arm, wherein the long arm protrudes from the screwdriver mounting handle via the through hole, and the short arm is fixedly clamped in the positioning groove.

2. The screwdriver of claim 1, wherein the screwdriver mounting handle further comprises a positioning member and a fixing member, the through hole and the positioning groove are defined in the positioning member.

3. The screwdriver of claim 1, wherein the screwdriver mounting handle further comprises a receiving portion, the positioning groove is defined in a bottom of the receiving portion, the through hole is defined in a bottom of the positioning groove, the fixing member is received in the receiving portion and resists against the short arm for clamping the short arm between the fixing member and the positioning member.

4. The screwdriver of claim 3, wherein the screwdriver mounting handle further comprises a fastener, a mounting groove is recessed in a bottom of the receiving portion and is spaced from the positioning groove, the fixing member defines a fixing hole, the fastener passes through the through hole and is locked in the mounting groove.

5. The screwdriver of claim 3, wherein sidewalls of the through hole and the positioning groove cooperatively define a receiving space, the tool is substantially T-shaped, and the receiving space is also substantially T-shaped.

6. The screwdriver of claim 1, wherein the screwdriver mounting handle comprises a receiving portion, the through hole and the positioning groove are defined in the receiving portion along a longitudinal direction thereof, the through hole is located adjacent to the screwdriver mounting handle, the fixing member is fixedly clamped in the through hole and resists against the long arm for clamping the short arm between the fixing member and the positioning member.

7. The screwdriver of claim 1, wherein the screwdriver mounting handle is made of a metal.

8. The screwdriver of claim 1, wherein the screwdriver mounting handle is made of high strength material.
